(19) United States
(12) Patent Application Publication
(10) Pub. No.: US 2026/0201573 A1
(43) Pub. Date: Jul. 16, 2026

(54) ELECTROCHEMICAL SYNTHESIS METHOD FOR LITHIUM SUPEROXIDE

(71) Applicant: UCHICAGO ARGONNE, LLC, Chicago, IL (US)

(72) Inventors: Larry A. CURTISS, Downers Grove, IL (US); Hsien-Hau WANG, Downers Grove, IL (US); Khalil AMINE, Oakbrook, IL (US); Samuel PLUNKETT, Chicago, IL (US)

(73) Assignee: UCHICAGO ARGONNE, LLC, Chicago, IL (US)

(21) Appl. No.: 19/548,191

(22) Filed: Feb. 24, 2026

Related U.S. Application Data
(62) Division of application No. 17/950,321, filed on Sep. 22, 2022, now Pat. No. 12,637,776.

(51) Int. Cl. C25B 1/14; C25B 11/032; C25B 11/043; C25B 11/093; H01M 4/38; H01M 4/48; H01M 10/0525

(52) U.S. Cl. CPC C25B 1/14; C25B 11/032; C25B 11/043; C25B 11/093; H01M 4/382; H01M 4/48; H01M 10/0525

(57) ABSTRACT

The present invention provides, in part, methods and processes for the production of lithium superoxide (LiO₂) which is free of other lithium-oxygen compounds, as well as compositions and electrochemical cells comprising lithium superoxide (e.g., lithium superoxide that is free of other lithium-oxygen compounds).

### CROSS-REFERENCE TO RELATED APPLICATIONS

This application is divisional of U.S. patent application Ser. No. 17/950,321, filed on Sep. 22, 2022, the contents of which are incorporated herein by reference in their entirety.

### STATEMENT OF GOVERNMENT INTEREST

This invention was made with government support under Contract No. DE-AC02-06CH11357 awarded by the U.S. Department of Energy. The government has certain rights in the invention.

### TECHNICAL FIELD

The present technology is generally related to the production of lithium superoxide (LiO₂) which is free of other lithium-oxygen compounds.

### BACKGROUND

There has been a significant interest in lithium superoxide (LiO₂), due to recent research into lithium-oxygen batteries, and the possibility that lithium superoxide may be an intermediate in the formation of lithium peroxide in lithium air cells. The first step in the oxygen reduction reaction (ORR) in a lithium air cell has been speculated to be the reduction of O₂ to O₂⁻, through a one-electron transfer, which is followed by the reaction with a lithium cation to form LiO₂ (Eqs. 1 and 2):

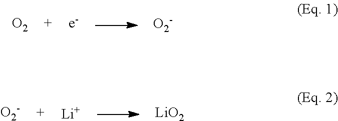

Lithium peroxide (Li₂O₂) can be then formed by the reaction of LiO₂ with Li⁺ through a second electron transfer, as shown in Eq. 3:

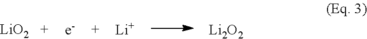

Alternatively, Li₂O₂ may be generated via the disproportionation reaction of LiO₂:

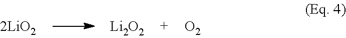

### SUMMARY

The present technology is based, in part, on the surprising discovery that lithium superoxide (LiO₂) can be prepared and stabilized at ambient temperature using the methods and compositions described herein.

Provided herein are methods and processes for the production of lithium superoxide (LiO₂) which is free of other lithium-oxygen compounds, as well as compositions and electrochemical cells comprising lithium superoxide (e.g., lithium superoxide which is free of other lithium-oxygen compounds).

In one aspect, disclosed herein is a process of forming LiO₂, the process comprising: providing an electrochemical cell comprising a porous oxygen cathode, a lithium anode, a current collector, and an electrolyte; and discharging the electrochemical cell to form a discharge product; wherein: the porous oxygen cathode comprises a gas-diffusion layer electrode coated with a mixture of reduced graphene oxide (rGO) and Ir₃Li; the discharge product comprises LiO₂; and the discharge product is substantially free of Li₂O and Li₂O₂.

In another aspect, disclosed herein is a composition comprising LiO₂, reduced graphene oxide (rGO), and Ir₃Li, wherein: a mass ratio of rGO:Ir₃Li is from about 1:1 to 1:0.00005; the LiO₂ comprises primary LiO₂ particles formed into secondary LiO₂ particles; the LiO₂ primary particles are less than about 5 nm; the LiO₂ secondary particles are greater than 200 nm; and the composition is substantially free of Li₂O₂ and Li₂O.

In another aspect, disclosed herein is an electrochemical cell comprising: an anode comprising lithium metal; a cathode comprising LiO₂, reduced graphene oxide (rGO), and Ir₃Li; and an electrolyte; wherein: a mass ratio of rGO:Ir₃Li is from about 1:1 to about 1:0.00005; and the cathode is substantially free of Li₂O₂ and Li₂O.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF THE DRAWINGS

FIG. 1A shows the XRD spectra of Ir₃Li sample with reference to ICSD standard (104488). FIG. 1B shows the SEM image of Ir₃Li powders post grinding with mortar and pestle. Scale bar is 10 μm. FIG. 1C shows the XPS spectra of Ir₃Li powders illustrating two components of a Ir4f_{7/2} peak at binding energy (BE) 59.98 eV (Ir₃) and 61.28 eV [Ir(0)] (Both in gray traces). FIG. 1D shows the 5×5 μm current image of a conductive AFM scan indicating high conductivity in bright color throughout the sample.

FIG. 2A shows the magnetic susceptibility (SQUID measurements) of Ir₃Li (black trace) with fitted curve (gray trace). FIG. 2B shows the heat capacity of Ir₃Li. FIG. 2C shows the EPR spectrum of Ir powder in O₂ atmosphere at 200 K. FIG. 2D shows the Ir₃Li and Ir EPR spectrum in O₂ atmosphere at 100 K and 200K, respectively. FIG. 2E shows the graphical representation of O₂ . . . Ir positions of non-equivalent Ir atoms.

FIG. 3A shows the Raman shift of Ir (black trace) starting material and synthesized Ir₃Li powder (gray trace). FIG. 3B shows the calculated phonon density of states of Ir₃Li with Ir—Li coupled modes (black trace) and vibration modes dominated by Li (gray trace). FIG. 3C shows the Raman spectra of Ir₃Li powder during extended exposure to air.

FIG. 4A shows the first five cycles of a Li—O₂ cell with rGO/GDL cathode, 1 M Li trifluoromethanesulfonate (Li triflate) in TEGDME electrolyte and current density 100 mA/g, illustrating a two-plateau charge profile. FIG. 4B shows the first five cycles of a Li—O₂ cell with Ir₃Li-rGO/GDL cathode, illustrating an initial high charge potential toward the end of the 1st charge cycle which tapered down and reached a charge potential below 3.5 V by the fourth cycle. Same electrolyte and current density as (a) were applied. FIG. 4C shows the deep discharge of Ir₃Li-rGO cathode in a Li—O₂ cell, showing the discharge potential ~2.75 V. FIG. 4D shows the Raman spectra of deep discharged Ir₃Li-rGO cathode in a Li—O₂ cell, illustrating strong LiO₂ peaks at different areas.

FIG. 5A shows the low resolution TEM image of the discharge product particle. FIG. 5B shows the electron diffraction pattern of the discharge product particle (LiO₂). FIG. 5C shows the TEM image snapshots during electron beam irradiation of the discharge product particle. FIG. 5D shows the high resolution image of particle formed during electron beam irradiation of the discharge product (particle circled in white in last video tile). FIG. 5E shows the electron diffraction pattern of Li₂O particle formed during electron beam irradiation of initial discharge product.

FIG. 6A shows the SEM image of the as synthesized Ir₃Li, illustrating many particles that clustered together. FIG. 6B shows the XPS of pristine Ir powders (black trace) showing three components of Ir 4f_{7/2} peak at binding energy (BE) 60.78 eV [Ir(0)], 62.08 eV [IrO₂], and 62.78 eV [unknown impurity], all in gray traces, respectively. Dark gray trace is the baseline. FIG. 6C shows the 3D morphology map of Ir₃Li (5×5 μm), showing particles ~1-3 microns.

FIG. 7A shows the EPR spectra of empty tube filled with O₂ at room temperature (gray trace) and 100 K (stronger signal, black trace). FIG. 7B shows the EPR spectra of iridium (black trace) and Ir₃Li (gray trace) in argon atmosphere at room temperature.

FIG. 8 shows the DFT calculated phonon density of states of iridium with major vibration mode.

FIG. 9 shows the UV-Vis absorbance curve of titrant resulting from deep discharge cathode Li₂O₂ titration.

### DETAILED DESCRIPTION

Current lithium-oxygen (Li—O₂) batteries suffer from large charge overpotentials related to electronic resistivity of the insulating lithium peroxide (Li₂O₂) discharge product. One potential solution to this challenge is the stabilization of the lithium superoxide (LiO₂) discharge intermediate, which has much higher electronic conductivity compared to Li₂O₂. Cathodes based on small iridium (Ir) nanoparticles have been recently used in a Li—O₂ battery to successfully stabilize the LiO₂ product, however, the LiO₂ had a short lifetime. Accordingly, there is a need for developing new methods for the preparation and/or stabilization of lithium superoxide (LiO₂), as well as compositions comprising the stabilized lithium superoxide (LiO₂) and use thereof.

The present disclosure provides processes for forming lithium superoxide (LiO₂), as well as compositions and/or electrochemical cells comprising the resulting lithium superoxide (LiO₂). The lithium superoxide (LiO₂) described herein can be free of other lithium-oxygen compounds.

As used herein, the term “approximately” or “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term. For example, in certain embodiments, the term “approximately” or “about” refers to a range of values that fall within 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, the phrase “free of” or “substantially free of” means that in the compositions, the Li₂O₂ and/or the Li₂O are undetectable using spectroscopic methods. For example, “free of” or “substantially free of” may mean greater than 98% purity of the LiO₂, greater than 99% purity of the LiO₂, or greater than 99.9% purity of the LiO₂. In some embodiments, “free of” or “substantially free of” may mean 100% purity of the LiO₂.

Throughout the description and claims of this specification the word “comprise” and other forms of the word, such as “comprising” and “comprises”, means including but not limited to, and is not intended to exclude, for example, other additives, components, integers, or steps.

“Optional” or “optionally” means that the subsequently described event or circumstance may or may not occur, and that the description includes instances where the event or circumstance occurs and instances where it does not.

As used herein, alkyl groups include straight chain and branched chain alkyl groups having from 1 to 12 carbon atoms, and typically from 1 to 10 carbons or, in some embodiments, from 1 to 8, 1 to 6, or 1 to 4 carbon atoms. Alkyl groups may be substituted or unsubstituted. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above, and include without limitation haloalkyl (e.g., trifluoromethyl), hydroxyalkyl, thioalkyl, aminoalkyl, alkylaminoalkyl, dialkylaminoalkyl, alkoxyalkyl, carboxyalkyl, and the like.

Alkyl groups described herein having two or more points of attachment (i.e., divalent, trivalent, or polyvalent) within the compound of the present technology are designated by use of the suffix, “ene.” For example, divalent alkyl groups are alkyl “ene” (“alkylene”) groups.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

### Methods of Preparation

In one aspect, provided herein is a process of forming lithium superoxide (LiO₂) using an electrochemical cell. For example, the process may comprise: providing an electrochemical cell, and discharging the electrochemical cell to form a discharge product (e.g., a discharge product comprising LiO₂). In some embodiments, the electrochemical cell comprises a porous oxygen cathode (e.g., a porous oxygen carbon cathode), a lithium anode, a current collector, and an electrolyte. In some embodiments, the porous oxygen cathode comprises a gas-diffusion layer electrode coated with a mixture of reduced graphene oxide (rGO) and Ir₃Li.

In some embodiments, the electrochemical cell comprises a porous oxygen carbon cathode comprising a gas-diffusion layer electrode coated with a mixture of reduced graphene oxide (rGO) and Ir₃Li. In some embodiments, a mass ratio of rGO:Ir₃Li in the mixture is from about 1:1 to about 1:0.00005, including about 1:1, about 1:0.1, about 1:0.001, about 1:0.0001, about 1:0.00005, or any value therebetween. In some embodiments, a mass ratio of rGO:Ir₃Li in the mixture is about 1:1. In some embodiments, a loading of the mixture on the porous oxygen carbon cathode is from about 0.2 to about 1.0 mg/cm², including about 0.2 mg/cm², about 0.4 mg/cm², about 0.6 mg/cm², about 0.8 mg/cm², about 1.0 mg/cm², or any value therebetween.

In some embodiments, the Ir₃Li described herein can be prepared by subjecting a mixture of Ir⁰ (e.g., Ir⁰ powder) and Li⁰ (e.g., Li⁰ foil) to elevated temperature to form the Ir₃Li. The resulting Ir₃Li then can be mixed with reduced graphene oxide (rGO) to form a mixture. In some embodiments, the elevated temperature is a temperature from about 600° C. to 1000° C., including about 600° C., about 700° C., about 800° C., about 900° C., about 1000° C., or any value therebetween. In some embodiments, the subjecting is carried out under an inert atmosphere. In some embodiments, the subjecting is carried out for greater than 3 days or greater than 5 days.

In some embodiments, the Ir₃Li described herein comprises Ir₃Li particles having a particle size of from about 200 nm to about 5 μm, including about 200 nm, about 400 nm, about 600 nm, about 800 nm, about 1 μm, about 2 μm, about 3 μm, about 4 μm, or about 5 μm, or any value therebetween. In some embodiments, the Ir₃Li described herein comprises Ir₃Li particles having a particle size of less than about 200 nm. In some embodiments, the Ir₃Li described herein comprises Ir₃Li particles having a particle size of greater than about 5 μm,

In some embodiments, the electrochemical cell comprises electrolytes. In some embodiments, the electrolytes are aprotic and may include a solvent and a salt (e.g., lithium salt) in addition to other additives that may be present.

The solvent may be an aprotic solvent such as an ether-based solvent, a fluorinated ether-based solvent, an oligo (ethylene oxide) solvent, or a mixture of any two or more thereof. Suitable solvents include, but are not limited to, glyme, diglyme, tetrahydrofuran, tetraethyletheylene glycol dimethylether, tri (ethylene glycol)-substituted methyltrimethyl silane (1NM3), ethylene glycol-substituted methyltrimethyl silane (1NM1), and di (ethylene glycol)-substituted methyltrimethyl silane (1NM2). Other suitable solvents include, but are not limited to, acetonitrile (ACN), dimethyl sulfoxide (DMSO), dimethylformamide (DMF), triethyl phosphate, N,N-dimethylacetamide (DMA), N-methyl pyrrolidone (NMP), methoxybenzene, siloxanes, and ionic liquids.

Suitable salts include but are not limited to LiCF₃CO₂, LiC₂F₅CO₂, LiClO₄, LiBF₄, LiAsF₆, LiPF₆, LiPF₂(C₂O₄)₂, LiPF₄C₂O₄, LiCF₃SO₃, LiN(CF₃SO₂)₂, LiC(CF₃SO₂)₃, LiN(SO₂C₂F₅)₂), lithium alkyl fluorophosphates, Li(C₂O₄)₂, LiBF₂C₂O₄, Li₂B₁₂X₁₂₋ₚHₚ, Li₂B₁₀X_{10-y}H_{y}, or any combination of two or more thereof, where X is OH, F, Cl, or Br; p is 0, 1, 2, 3, 4, 5, 6, 7, 8, 9, 10, 11, or 12; and y is 0, 1, 2, 3, 4, 5, 6, 7, 8, 9, or 10.

Discharging an electrochemical cell described herein can form a discharge product comprising LiO₂. The discharging may be conducted in the presence of O₂. The discharging may further include cycling of the electrochemical cell, i.e. discharging and charging cycles.

The electrochemical cell can be cycled for a predetermined time, and at a predetermined capacity and current density. For example, a single cycle of the cell may be conducted for greater than 1 hour. In some embodiments, the cycle is conducted for from 1 hour to 48 hours, including from 2 hours to 24 hours, including from 12 hours to 24 hours, including 1 hour, 3 hours, 6 hours, 9 hours, 12 hours, 15 hours, 18 hours, 21 hours, or 24 hours, or any value therebetween. In some embodiments, the cycling (including the discharging) is conducted at a capacity of from about 100 mAh/g to about 2000 mAh/g, including about 100 mAh/g, about 200 mAh/g, about 300 mAh/g, about 400 mAh/g, about 500 mAh/g, about 600 mAh/g, about 700 mAh/g, about 800 mAh/g, about 900 mAh/g, about 1000 mAh/g, about 1100 mAh/g, about 1200 mAh/g, about 1300 mAh/g, about 1400 mAh/g, about 1500 mAh/g, about 1600 mAh/g, about 1700 mAh/g, about 1800 mAh/g, about 1900 mAh/g, or about 2000 mAh/g, or any value therebetween. In some embodiments, the cycling (including the discharging) is conducted at a current of from about 10 mA/h to about 500 mA/h, including about 10 mA/h, about 50 mA/h, about 100 mA/h, about 150 mA/h, about 200 mA/h, about 250 mA/h, about 300 mA/h, about 350 mA/h, about 400 mA/h, about 450 mA/h, or about 500 mA/h, or any value therebetween.

In some embodiments, the discharge product comprises LiO₂. In some embodiments, the discharge product is substantially free of Li₂O and Li₂O₂. As noted above, “free of” indicates, at least in some embodiments, that the LiO₂ is spectroscopically pure. For example, as described herein, the discharge product can be characterized using Raman spectroscopy, titration, Ultraviolet-visible spectroscopy, and transmission electron microscopy (TEM) study.

In some embodiments, the LiO₂ (e.g., the LiO₂ prepared by a method described herein) is crystalline LiO₂. In some embodiments, the LiO₂ (e.g., the crystalline LiO₂) is in a form of particles such as secondary particles. In some embodiments, the LiO₂ secondary particles comprises LiO₂ primary particles and amorphous regions between said LiO₂ primary particles. In some embodiments, the LiO₂ secondary particles described herein have a particle size of greater than about 100 nm, including greater than about 200 nm, greater than about 400 nm, greater than about 600 nm, or greater than about 1 μm. In some embodiments, the LiO₂ primary particles described herein have a particle size of less than about 5 nm, less than about 10 nm, or less than about 15 nm. In some embodiments, the primary LiO₂ and the secondary LiO₂ are crystalline.

The lithium superoxide produced may find application in lithium air batteries, as a cathode material for a closed Li-air battery systems without need for a source of oxygen for the storage of oxygen, in solid form with low molecular weight, and as a lithium storage material to pre-lithiate high-energy anodes.

Compositions and/or Electrochemical Cells

In another aspect, provided herein is a composition comprising lithium superoxide (LiO₂), reduced graphene oxide (rGO), and Ir₃Li. In any of the embodiments described herein, the composition may be substantially free of other lithium-oxygen compounds such as lithium peroxide (Li₂O₂) or lithium oxide (Li₂O). As noted above, “free of” indicates, at least in some embodiments, that the LiO₂ is spectroscopically pure. As described herein, the mass of Li₂O₂ present on a discharged Ir₃Li-rGO electrode can be determined using titration with titanium oxysulfate solution Ti(IV)OSO₄ coupled with Ultraviolet-visible spectroscopy (UV-Vis). Additionally, the TEM characterization can provide further evidence that the discharge product is mainly LiO₂, and upon high energy electron irradiation, decompose to form Li₂O.

In some embodiments, a mass ratio of rGO:Ir₃Li in the composition is from about 1:1 to about 1:0.00005, including about 1:1, about 1:0.1, about 1:0.001, about 1:0.0001, about 1:0.00005, or any value therebetween. In some embodiments, a mass ratio of rGO:Ir₃Li in the composition is about 1:1.

In some embodiments, the Ir₃Li described herein comprises Ir₃Li particles having a particle size of from about 200 nm to about 5 μm, including about 200 nm, about 400 nm, about 600 nm, about 800 nm, about 1 μm, about 2 μm, about 3 μm, about 4 μm, or about 5 μm, or any value therebetween. In some embodiments, the Ir₃Li described herein comprises Ir₃Li particles having a particle size of less than about 200 nm. In some embodiments, the Ir₃Li described herein comprises Ir₃Li particles having a particle size of greater than about 5 μm.

In some embodiments, the LiO₂ is crystalline LiO₂. In some embodiments, the LiO₂ (e.g., the crystalline LiO₂) comprises primary LiO₂ particles formed into secondary LiO₂ particles. In some embodiments, the LiO₂ secondary particles further comprises amorphous regions between the LiO₂ primary particles. In some embodiments, the LiO₂ secondary particles described herein have a particle size of greater than about 100 nm, including, greater than about 200 nm, greater than about 400 nm, greater than about 600 nm, or greater than about 1 μm. In some embodiments, the LiO₂ primary particles described herein have a particle size of less than about 5 nm, less than about 10 nm, or less than about 15 nm. In some embodiments, the primary LiO₂ and the secondary LiO₂ are crystalline.

The LiO₂ described herein (e.g., the LiO₂ included in the composition) can exhibit superior stability. For example, the LiO₂ may be stable after 24 hours at ambient temperature under O₂, Ar, or vacuum. In some embodiments, the LiO₂ is stable with less than 20%, less than 15%, less than 10%, or less than 5% of LiO₂ decomposes after 24 hours at ambient temperature under 02, Ar, or vacuum. Additionally or alternatively, the LiO₂ may be stable under 80 kV applied voltage. In some embodiments, the LiO₂ is stable with less than 3%, less than 1%, or less than 0.5% of LiO₂ is decomposed under 80 kV applied voltage during TEM measurement.

In another aspect, provided herein is an electrochemical cell. The electrochemical cell may comprise 1) an anode comprising lithium metal; 2) a cathode comprising LiO₂ (e.g., the LiO₂ as described herein), reduced graphene oxide (rGO), and Ir₃Li(e.g., the Ir₃Li as described herein); and 3) an electrolyte (e.g., the electrolytes as described herein). In some embodiments, a mass ratio of rGO:Ir₃Li in the electrochemical cell is from about 1:1 to about 1:0.00005, including about 1:1, about 1:0.1, about 1:0.001, about 1:0.0001, about 1:0.00005, or any value therebetween. In some embodiments, a mass ratio of rGO:Ir₃Li in the electrochemical cell is about 1:1.

In some embodiments, the cathode is substantially free of Li₂O₂ and Li₂O.

### EXAMPLES

The following examples illustrate some embodiments and aspects of the invention. It will be apparent to those skilled in the relevant art that various modifications, additions, substitutions, and the like can be performed without altering the spirit or scope of the invention, and such modifications and variations are encompassed with invention as defined in the claims which follow. The invention disclosed herein is further illustrated by the following examples which in no way should be construed as being limiting.

### Example 1—General Methods

Provided herein are certain general methods used in the examples.

XRD characterization. Powders of Ir₃Li were wax sealed in a thin quartz x-ray tube inside a glovebox filled with Ar. The XRD measurements were performed at the Argonne Advanced Photon Source (APS) sector 11-ID-C high energy diffraction beamline equipped with a 2D area detector. CeO₂ was used as a calibration standard. A 2D diffraction pattern was taken and then an azimuthal averaging was carried out to generate a 0-20 XRD pattern. The x-ray wavelength applied was 0.117418 Å.

TEM coupled electron diffraction (Titan, FEI) was used to analyze the synthesized Ir₃Li nanopowders and the discharged Ir₃Li-rGO electrodes. Ir₃Li TEM samples were prepared by directly adding Ir₃Li powder to amorphous carbon grids supported on a 300-mesh copper (Ted Pella Inc.), then washing with ethanol dropwise to remove most of the material. The small amount of material remaining on the grid was then dried for 30 min under a heat lamp before being transferred to the TEM apparatus. Discharged Ir₃Li-rGO electrode TEM samples were prepared in a similar fashion; however, after cell disassembly in an argon filled glovebox the cathode was removed and dried before a doctor blade was used to scrape discharged material from the surface of the electrode. SEM (Hitachi S-4700) was used to determine Ir₃Li morphology and particle size.

Raman spectroscopy (Renishaw in Via) was performed on the Ir₃Li powders using a HeNe laser with a wavelength of 633 nm. Ten percent of the maximum 13 mW laser power was used, and spectrum collection was set up in a 180° reflective mode with a time constant of 200 seconds (“s”). The Ir₃Li samples were mounted on a silicon chip, and the monochromator was calibrated against a diamond thin film standard (1332 cm⁻¹) and a silicon chip (520 cm⁻¹). When LiIr₃ was first synthesized, stability toward air was unknown. Therefore, initial Raman measurements were carried out with use of a custom-made, air-tight cell with a glass window under Ar. Raman spectroscopy was also performed on discharged cathodes. In this case, the cycled cathode was placed inside the custom cell during Raman testing to prevent oxidation of discharge products. The removal of the cathode from the electrochemical cell after testing and assembly inside the Raman cell was performed inside an argon filled glovebox.

SQUID measurements were carried out on Ir₃Li pellets formed by hand pressing Ir₃Li powder. Magnetic susceptibility was measured as a function of temperature between 1.8 and 110 K. EPR measurements were performed using a Bruker/IBM ER-200 X-band spectrometer equipped with a TE₁₀₂ rectangular microwave cavity. Temperature was controlled between ambient down to 100 K using of a 4111 VT variable temperature controller by evaporating liquid nitrogen through a pipe equipped with a heating coil. Temperature-dependent EPR data were collected at 9.49 GHz with a 100 kHz field modulation. A strong-pitch standard (g=2.0028) was used for g value calibration. A quartz 4 mm diameter EPR tube with a gas tight rubber septum was used as the sample/gas holder. Ultra-high purity O₂ (99.999%) was applied throughout the experiments. Commercial Ir fine powders suspended in water were centrifuged, filtered, washed with water then alcohol, and vacuum dried at 100° C. before analysis.

XPS measurements were carried out on a Thermo Scientific K-Alpha+ spectrometer using a micro-focused monochromatic Al Kα (1487 eV) X-ray source with a spot size of 400 μm for the surface analysis. High-resolution XPS scans were performed for C 1s, O 1s, Li 1s, and Ir 4f at the relevant binding energy range for these elements. The spectra were processed using Thermo Scientific Advantage (v. 5.977, Build 06436) post-processing software. Charge-correction was performed by referencing to the adventitious C Is peak arising at 284.8 eV. Peak deconvolution of the HR-XPS spectra was performed using mixed Gaussian-Lorentzian (~30% L/G) line shapes and Smart backgrounds.

CAFM was carried out with a Digital Instrument Nanoscope Dimension 3000 with controller IV. The multimode scanning unit equipped with a CAFM module was housed inside of a glovebox. The morphology and current map were obtained simultaneously through direct contact with a conductive tip.

Electrochemical tests were carried out using a Swagelok type cell. The cell stack assembly (cathode-separator/electrolyte—anode) was assembled in an argon filled glove box with <0.1 ppm O₂ and <0.1 ppm H₂O. Swagelok cells were assembled with a 7/16″ diameter Li foil anode, a ½″ diameter electrolyte-soaked separator and a 7/16″ positive electrode. A 1 M Li trifluoromethanesulfonate (LiCF₃SO₃; 99.995% trace metals basis, Aldrich Chemistry) in tetraethylene glycol dimethyl ether (TEGDME; 99%, Aldrich Chemistry) solution was used as the electrolyte for electrochemical tests. The LiCF₃SO₃ was dried in Ar at 110° C. for 24 h before use. TEGDME was degassed by pouring the liquid into a Schlenk flask and repeatedly evacuating and refilling with argon three times before transferring to an argon filled glove box. The degassed solvent was then dried over a bed of 3 Å molecular sieves for 1 week before use. Karl-Fischer titrations confirmed a moisture content of less than 30 ppm after drying. The prepared electrolyte was added dropwise to the separator in the electrochemical cells. After assembly, the Swagelok cell was placed inside a custom-built glass vessel via an air-tight union in the middle of the glassware. The vessel was manufactured with gas inlet and outlet valves and positive and negative copper wires sealed into the glass. Once assembled, the glassware containing the Swagelok cell was transferred to the glovebox and purged with O₂ at 1 bar pressure for 30 min prior to electrochemical testing. Swagelok electrochemical measurements including open circuit voltage (OCV) and galvanostatic discharge/charge tests were made with a MACCOR battery cycler. Discharge/charge tests were conducted at a constant current of 100 mA/g of cathode active mass.

All the DFT calculations were performed using VASP software that utilized the projector augmented wave (PAW) method and generalized gradient approximation (GGA) with Perdew-Burke-Ernzerhof (PBE) functionals. All the optimized structures of Ir and Ir₃Li crystals were obtained with force convergence criterion on each atom of 0.01 eV/Å, energy convergence of 10-7 eV, with energy cutoff of 500 eV for plane wave basis set and a K-point mesh 8×8×8. The phonon frequencies were obtained based on a finite difference method by computing the Hessian matrix implemented in the Vienna Ab initio Simulation Package (VASP) code [13].

### Example 2—Preparation and Characterization of Ir₃Li

### Ir₃Li Synthesis.

Ir₃Li synthesis was performed similar to that reported previously [11]. Ir powder (Aldrich powders, 99.9%) and Li foil (MTI, 99.9%) were sealed in a tantalum tube inside an argon filled glovebox using a 3:1.2 Ir:Li molar ratio. The lithium foil was carefully placed over the Ir powders to keep the two reagents in close contact. The tantalum tube with a crimped lid was taken out of the glovebox and immediately sealed with an arc torch under argon. The tantalum tube was further sealed in a quartz tube under vacuum using an oxygen torch. Care was taken to keep both reagents settled on the bottom of the tantalum tube. The tantalum in quartz tube was heated to 800° C. for 8 days then furnace-cooled to room temperature. The quartz tube was broken, and the tantalum tube was placed back into the argon filled glovebox. The tantalum tube was cut and the Ir₃Li product was recovered as loose gray-black powders.

### Ir₃Li Characterization.

### XRD Characterization.

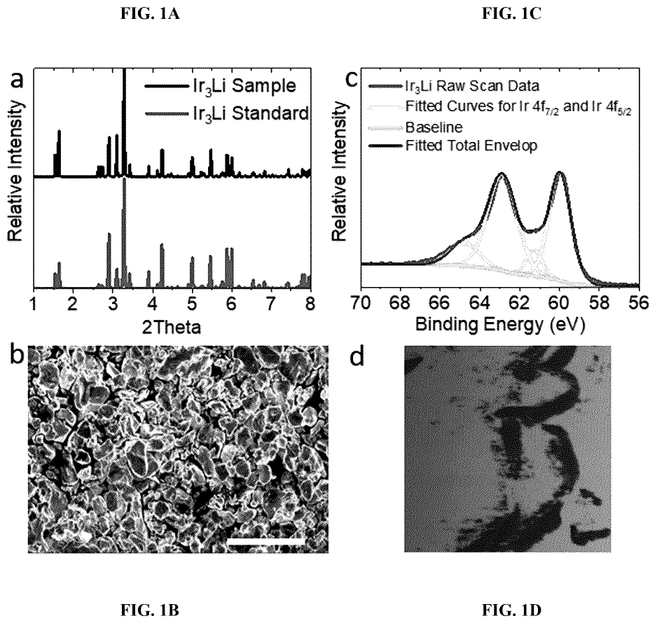

The synthesized Ir₃Li powders were analyzed with use of the XRD technique at Argonne's high resolution synchrotron beamline. Metallic Ir was not observed and the XRD spectrum was nearly identical to that of the ICSD Ir₃Li standard, thereby confirming phase pure Ir₃Li formation. FIG. 1A shows the Ir₃Li powder XRD spectrum with comparison to the ICSD standard (104488). The observed Ir₃Li (022) peak (2θ=3.2749) from the bulk synthesis formed a shoulder with the strongest Ir₃Li (121) peak at 2θ=3.2924.

### SEM Characterization.

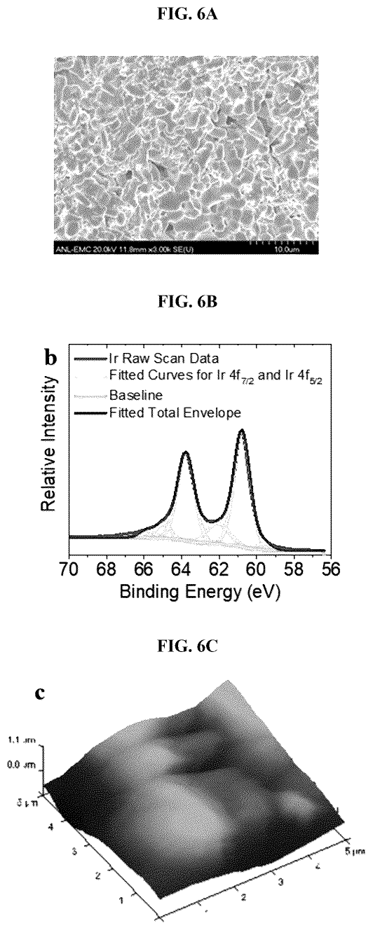

The Ir₃Li morphology was studied by SEM. Cathode morphology can significantly affect the LiO₂ and Li₂O₂ discharge product chemistry and morphology [14,15]. The SEM results for the synthesized Ir₃Li particles is shown in FIG. 6A. The as-synthesized Ir₃Li was composed of non-uniform ~2-10 μm particles. The reduction of Ir₃Li particle size compared to the starting iridium particle size (~100 μm) could be caused by the high temperature synthesis method, which allowed Li diffusion (Li atomic radius 0.152 nm) through the Ir particles (Ir atomic radius 0.135 nm) [16]. This process led to break-down of the iridium particles. The Ir₃Li particles were later broken down by mechanical grinding using an ultra-hard boron carbide mortar and pestle. The resulting particles, shown in FIG. 1B, ranged from 200 nm to 5 μm. The large particle size may not be necessarily optimized for a Li—O₂ cell in terms of rate capability and capacity [17]. However, as further explained, they are effective for stabilizing large LiO₂ deposits during cell discharge.

### XPS Characterization.

The XPS spectrum of Ir₃Li powders is shown in FIG. 1C. For comparison, XPS was also performed on the Ir starting material (FIG. 6B). The doublet located around a binding energy 60 eV can be assigned as the Ir 4f_{7/2} and 4f_{5/2} absorptions, with a separation of 3.0 eV that is consistent with the standard value of 2.98 eV [18]. The 4f_{7/2} peak of Ir is deconvoluted into three components: 60.78, 62.08, and 62.78 eV, respectively. These correspond to Ir metal Ir⁰, which is the main component, IrO₂ (Ir⁺⁴) as a surface oxidized Ir species, and an unknown trace impurity. The Ir₃Li Ir 4f_{7/2} peak is downward shifted to 59.98, and 61.28 eV for Ir₃⁻ and Ir₀, respectively. XPS chemical shifts are typically correlated to the oxidation state of the specific element with higher binding energy related to high oxidation state. Compared to that of the Ir⁰ with binding energy 60.8 eV, the 59.98 eV peak suggests that Ir atoms in Ir₃Li contain a more negative charge compared to Ir atoms in Ir⁰. An Ir that carries negative charge is rare and quite reactive, but has been reported previously such as Na[Ir(CO)₄] (Ir formally −1) and Na₃[Ir(CO)₃] (Ir formally −3) [19]. These metal carbonyl anions are typically strong reducing agents [20]. Charge distribution computed by DFT calculations based on Bader Charge Analysis aligned with these experimental XPS results. DFT analysis suggested the following charge distribution: Li~+0.81e, while Ir are ~−0.25e (two Ir) and −0.31e (one Ir) due to asymmetric position of Ir sites. The negative Ir charge in Ir₃Li provided the material with a higher tendency to donate electrons. As a result, the oxygen reduction reaction (ORR) reaction may be more facile when occurring on Ir₃Li surfaces compared to Ir⁰.

### CAFM Characterization.

CAFM analysis was also performed on the Ir₃Li particles inside of an Ar-filled glovebox to determine the electrical conductivity of the material, which is important for its use as an electrode.

The Conductive AFM (CAFM) was carried out with a Digital Instrument (DI, now Bruker) Nanoscope Dimension 3000 with a controller IV. The conductive tip was scanned horizontally and the dark areas in the current map indicated low conductivity due to much faster scanning tip movement across particle edges while bright areas revealed high conductivity. These low current areas well matched with the morphology image. More than five different areas were studied with consistent results. The resistance of the material was calculated based on Ohm's law (V=IR). That is, a stationary I-V scan was performed with the CAFM probe sitting on a particle with area of 11 □m dia, and 2 □m thickness. The I-V curve was linear (ΔV=ΔI·R) and the resistance, R, was calculated from the slope of the I-V curve, m, using Equation S1.

$$\frac{1}{R} = \frac{Δ I}{ΔV} = \frac{{I}_{2} - {I}_{1}}{{V}_{2} - {V}_{1}} = m \qquad ( S1 )$$

Upon considering the length of the sample through which the current was passing and the sampling area, the resistivity (p) of the Ir₃Li particles was 4.0·10⁻⁸ Ωm, which was

similar to iridium metal resistivity previously reported as 3.7·10⁻⁸ Ωm [22]. The Ir₃Li conductivity, σ, was then calculated from the resistivity using Equation S2.

$$σ = \frac{1}{ρ} \qquad ( S2 )$$

A 3-D image showing the morphology of the Ir₃Li powder sample is shown in FIG. 6C. A current map revealing conductivity of a particular region of the Ir₃Li powder sample is shown in FIG. 1D. The 3D image shows the topography of Ir₃Li particles ranging between 1 and 4 μm in size. The current map demonstrates uniformly high conductivity amongst the Ir₃Li particles and the conductivity of Ir₃Li was calculated. The Ir₃Li conductivity was determined as 2.5·10⁷ S/m, which is similar to that of Ir metal (2.7·10⁷ S/m) [22]. Thus, the CAFM results demonstrate the high electrical conductivity of Ir₃Li, which is needed for a cathode material.

### Squid Measurements.

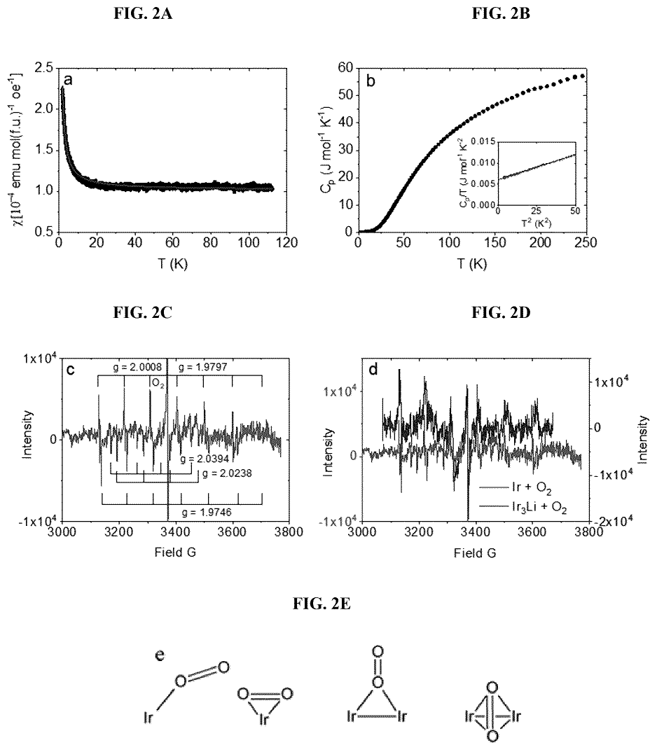

To investigate the effectiveness of Ir₃Li as an ORR/oxygen evolution reaction (OER) catalyst [17, 23-26] beyond its high electronic conductivity at ambient temperature, the magnetic susceptibility (χ) of Ir₃Li was measured as a function of temperature between 1.8 and 110 K in a magnetic field of μ₀H=0.01 T. The observed magnetic susceptibility is shown in FIG. 2A. To facilitate an estimate for the expected Pauli paramagnetic susceptibility, the heat capacity (Cₚ) was measured on a compacted pellet using the standard relaxation method. FIG. 2B shows the measured heat capacity, and the inset shows the same data in the form of Cₚ/T vs T² in the low temperature regime (T²<50 K²).

From heat capacity measurements, Pauli's susceptibility was calculated to be 8.4×10⁻⁵ emu mol⁻¹ Oe⁻¹. After correcting for Landau diamagnetic susceptibility

$$( \frac{- {χ}_{Pauli}}{3} ) ,$$

a susceptibility of conduction electrons χ_{Pauli}+χ_{Landau}=5.57×10⁻⁵ emu mol⁻¹ Oe⁻¹ was obtained, which was approximately 45% smaller than the observed susceptibility from SQUID measurements (1.0×10⁻⁴ emu mol⁻¹ Oe⁻¹). Therefore, the magnetic susceptibility measurement together with heat capacity support that the temperature dependent behavior of Ir₃Li is in the metallic range, which is additional support for the ORR/OER properties of Ir₃Li.

### Pauli's Susceptibility Calculations

Above ~20 K, the magnetic susceptibility was approximately constant, whereas at lower temperatures an increase was observed as the temperature was lowered, suggestive of a Curie tail. The entire temperature dependence was thus fit as a combination of a temperature-independent term (χ₀) with a Curie-Weiss term, shown in Equation S3.

$$χ = {χ}_{0} + \frac{C}{T - θ} \qquad ( S3 )$$

where C is the Curie Constant. The fit, shown in FIG. 2A, yielded a Curie-Weiss temperature of 0.38 K and an effective moment of 0.038μ_{B} per formula unit. These values were suggestive of a low density of non-interacting moments which might arise from defects and/or a trace number of impurities. The fitted χ₀ per formula unit was 1.0×10⁻⁴ emu mol⁻¹ Oe⁻¹; while this could be interpreted as consistent with metallic Pauli paramagnetism, the raw measured moments in the regime dominated by χ₀ (~6×10⁻⁷ emu) were small and may be affected by the container background.

### Heat Capacity Measurements

In the low temperature limit, the heat capacity of a metal is anticipated to take the form of Equation S4.

$${C}_{p} = γ T + β {T}^{3} \qquad ( S4 )$$

where γT represents the electronic contribution (y is the Sommerfeld coefficient) and βT³ represents the lattice contribution in a Debye model. Thus, the intercept and slope of the inset yield γ and β, which were determined by fitting to be 6.09 mJ mol⁻¹ K⁻² and 0.119 mJ mol⁻¹ K⁻⁴ respectively. From the value of β, the Debye Temperature, θ_{D}, could be determined to be 403 K via Equation S5.

$${θ}_{D} = {( \frac{234 {Nk}_{B}}{β} )}^{1 / 3} \qquad ( S5 )$$

where N is the number of atoms per mole (here, 4N_{A}). From the Sommerfeld Coefficient, the density of states at the Fermi level, g(E_{F}), can be estimated in a free-electron approximation via Equation S6.

$$g ( {E}_{F} ) = \frac{3 γ}{{π}^{2} {k}_{B}^{2}} \qquad ( S6 )$$

In a free-electron model, the Pauli susceptibility is then proportional to g(E_{F}), as shown in Equation S7.

$${χ}_{Pauli} = {μ}_{B}^{2} g ( {E}_{F} ) = \frac{3 {γμ}_{B}^{2}}{{π}^{2} {k}_{B}^{2}} \qquad ( S7 )$$

This leads to a calculated value of χ_{Pauli} of 8.4×10⁻⁵ emu mol⁻¹ Oe⁻¹.

### EPR Characterization.

EPR measurements were carried out between room temperature and 100 K in order to probe the affinity of Ir₃Li toward O₂ adsorption, which is essential to enable effective OER/ORR charge transfer in Li—O₂ batteries.

FIG. 2C shows the EPR spectra of Ir powder at 200 K in a 1 atm O₂ atmosphere and indicates that Ir powders clearly have a strong affinity toward oxygen molecules, which gives rise to the fine coupling peaks. FIG. 2D shows a comparison between the EPR spectrum of Ir₃Li powders with O₂ (100 K) and Ir powders with O₂ (200 K). The EPR signals from Ir₃Li/O₂ have a very similar pattern compared to that of Ir/O₂, implying that molecular oxygen is also adsorbed onto Ir₃Li in a similar fashion. The low EPR signal intensity from Ir₃Li/O₂ may be due to a low Ir content per surface area comparing to that of the Ir/O₂. The EPR results suggest that both Ir and Ir₃Li powders adsorb oxygen in the gas phase. The surface adsorbed O₂ molecules interact with Ir and Ir₃Li through two-atom (7 peaks each for ¹⁹¹Ir and ¹⁹³Ir) and/or mono-atom (4 peaks each for two Ir isotopes) modes as shown in FIGS. 2C-2E. These interactions in a real Li-O₂ cell are expected to be similar but more complex due to competition from electrolyte (such as TEGDME and Li salt).

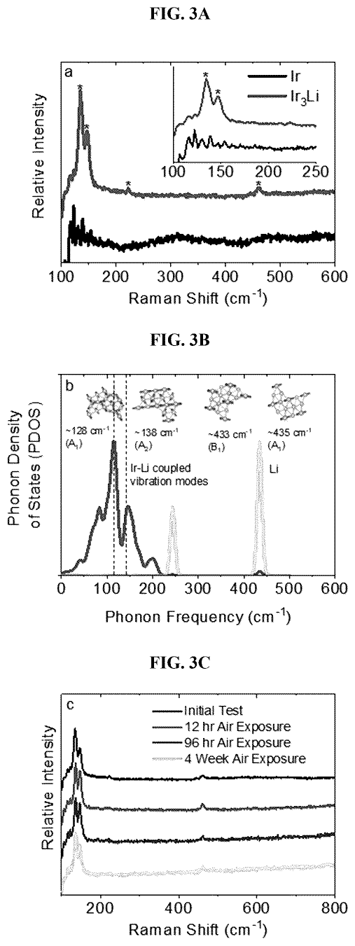

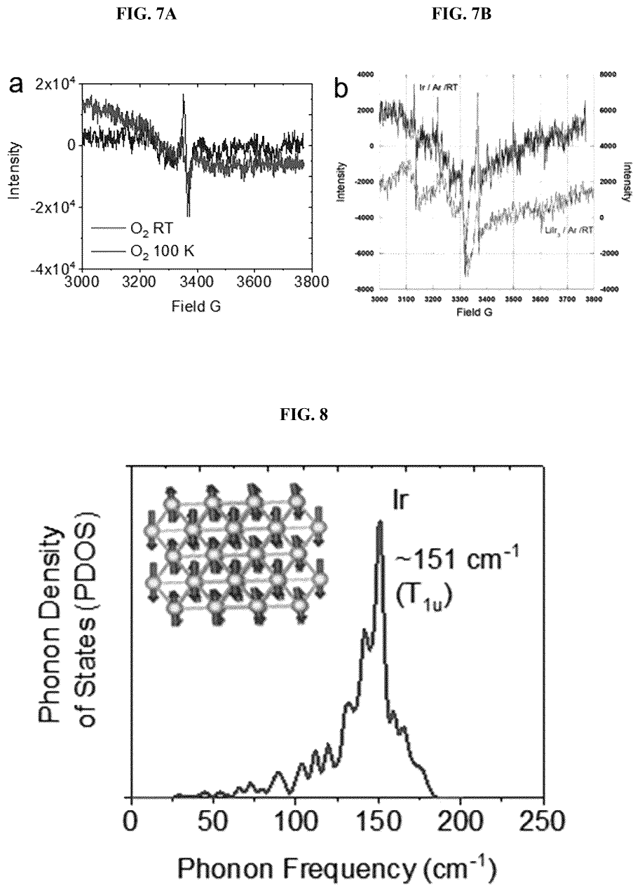

As shown in FIG. 7A, one atmosphere O₂ at room temperature and 100 K gave a distorted EPR signal with an apparent peak-to-peak linewidth of 16.6 G (100 K, g=2.0067). This EPR signal originated from the triplet ground state of O₂ molecules. FIG. 7B shows results for commercial Ir powders (~2 mg) under argon. Comparing to Ir powders under O₂ (FIG. 3C), the EPR signals for Ir under Ar are very similar but much weaker. This observation suggests that the signals are coming from O₂ molecules that physiosorbed on the Ir surface. A notable sharp peak (ΔHₚ₋ₚ~4 G, g=2.0008) near the center field can be attributed to low concentration of O₂ such as adsorbed surface O₂. The sharper nature comparing to free 1 atm O₂ (FIG. 7A) is due to lower O₂ concentration in the presence of Ir powders and dipole-dipole interactions between paramagnetic centers and exchange sharpening [2]. Many additional sharp but weak peaks may be due to trace amount of surface adsorbed O₂ that coupled to Ir (vide infra). In FIG. 7B shows Ir₃Li powders (~3 mg) under argon. A similar sharp peak in the middle (physisorbed O₂ on surface) and a few broad pumps were noticed. As shown in FIG. 7B, the EPR spectrum of Ir₃Li under Ar at ambient temperature only revealed an adsorbed O₂ peak near the center field.

As shown in FIG. 2C, the EPR spectrum of Ir powder in 1 atm O₂ was fully developed at 200 K. The strong and sharp peak in the middle (ΔHₚ₋ₚ 2.5 G) of FIG. 2C can be attributed to triplet O₂ (³Σ) which was the ground state of molecular O₂. The sharp linewidth of 2.5 G in contrast to the distorted and broad linewidth of 16.6 G implied most of the O₂ were adsorbed onto the Ir powders [3]. There were two sets of septuplets due to O₂ molecule coupled to two Ir atoms (I=3/2, 2nI+1=7, g=1.9797 and 1.9746). The two sets were likely caused by the natural abundance of Ir isotopes (¹⁹¹Ir 37.4% and ¹⁹³Ir 62.6%). The probability of Ir—Ir neighbor approximately follows ¹⁹³Ir-¹⁹³Ir, ¹⁹³Ir-¹⁹¹Ir, and ¹⁹¹Ir-¹⁹¹Ir=0.392, 0.234, and 0.140, respectively. In addition, there were two more sets of quartets resulting from molecular O₂ coupled to a single Ir atom (2nI+1=4). The two sets of quartets were also caused by the same Ir naturally existed isotopes (g=2.0394 and 2.0238). O₂ adsorption may take either end-on or bridging mode as shown in FIG. 2e that would further broaden the EPR signals.

### Raman Characterization.

Micro-Raman spectroscopy was performed on the Ir₃Li powder to determine its spectra compared to Ir metal and to investigate its stability in O₂. The Raman spectra is shown in FIG. 3A, with comparison to the Ir nanoparticle raw material. Raman signals for Ir₃Li are located at 134.7, 147.0, 222.3, and 462.6 cm⁻¹. The phonon density of states of Ir₃Li crystals were calculated using DFT and are shown in FIG. 3B. The calculated Raman frequencies below 200 cm⁻¹ are associated with Ir—Li coupled vibrational A₁ and A₂ modes. The high frequency Raman modes are associated with A₁ and B₁ vibrational modes dominated by Li in the lattice. The phonon density of states of Ir was also calculated using DFT and is shown in FIG. 8. According to the symmetry group (Oₕ symmetry) of a perfect Ir crystal, the predicted dominant phonon vibration mode (T₁ᵤ) is at ~151 cm⁻¹ (FIG. 8), which is Raman inactive and is distinct from Ir₃Li. Thus, these results show that Raman spectroscopy can be used to differentiate Ir₃Li from Ir. In addition, to probe the stability of Ir₃Li to O₂ required for Li—O₂ batteries, the Ir₃Li sample was exposed to an ambient atmosphere for 4 weeks. Raman measurements performed on the sample after 12 hours (“hr”), 96 hr, and 4 weeks of exposure found that the Raman spectra similar in all cases, as shown in FIG. 3C, indicating that bulk Ir₃Li is stable in air for an extended period of time.

### Example 3—Preparation and Electrochemical Evaluation of IrLi₃-rGO Cathodes

To make battery cathodes, Ir₃Li was first ground for 30 minutes using an ultra-hard boron carbide mortar and pestle to separate the partially sintered particles. The Ir₃Li-rGO positive electrodes were fabricated by first mixing rGO (reduced Graphene Oxide, carbon >75 wt. %, Sigma Aldrich) and Ir₃Li powder in a 1:1 ratio, with N-methyl-2-pyrrolidone (NMP) and polyvinylidene fluoride (PVDF) binder so that the mass ratio of Ir₃Li-rGO to PVDF was 9:1. The slurry was mixed for 30 min using a mortar and pestle. The mixture was then coated onto a gas-diffusion layer (GDL) disc (FuelCellEtc Sigracet 35BC and/or TGP-H-030 carbon paper, Toray) and dried under vacuum at 100° C. for 24 h. The final mass loading of Ir₃Li-rGO was ~0.3-0.8 mg/cm².

### Example 4—Cell Performance and Discharge Product (LiO₂) Characterization

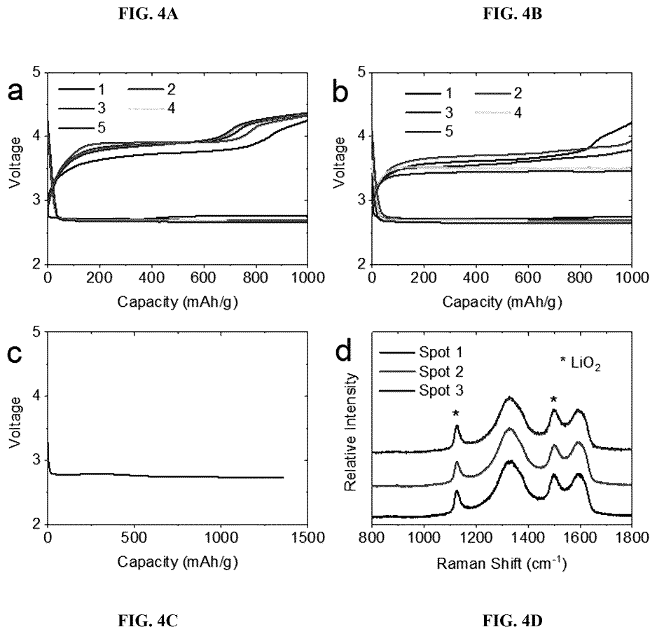

An Ir₃Li and rGO 1:1 mixture was added to a GDL (gas diffusion layer) electrode using PVDF binder to form an Ir₃Li-rGO cathode. The resulting cathode was assembled in a Swagelok type Li—O₂ cell with a Li metal anode and a 1 M Li triflate in TEGDME soaked glass fiber separator. The cell was purged with oxygen gas for 30 minutes then sealed under 1 atm of O₂. For comparison, a similar Li—O₂ cell with an rGO/GDL cathode was also assembled. Both cells were cycled at a current density of 100 mA/g and capacity of 1000 mAh/g. The first five electrochemical discharge-charge cycles are shown in FIG. 4A and FIG. 4B for the rGO/GDL and Ir₃Li-rGO/GDL cells, respectively. For the Li—O₂ cell with the rGO/GDL cathode, two charge plateaus at ~3.6-3.8 and 4.2 V were observed. For the Li—O₂ cell with the Ir₃Li-rGO/GDL cathode, the charging potential remained mostly below 3.7-3.5 V except towards the end of the first charging cycle. Since both Ir and Ir₃Li powders may contain trace amounts of adsorbed surface O₂ (see XPS and EPR sections), a small overpotential on the Ir₃Li-rGO/GDL cathode during the first discharge is not unexpected.

For detailed discharge product(s) characterization on the Ir₃Li-rGO/GDL cathode, a different cell was discharged at 62.5 mA/g current density to a capacity of 1360 mAh/g. The larger capacity experiment was performed to increase the mass of the discharge product deposited on the cathode to enable Raman and titration analysis of the discharge product(s). The voltage profile during cycling of the cell is shown in FIG. 4C. The discharge overpotential was stable between 0.15-0.25 V throughout the entire discharge, thus enabling the reasonably large capacity (>1000 mAh/g) of the cathode.

The mass of Li₂O₂ present on a discharged Ir₃Li-rGO electrode was determined using titration with titanium oxysulfate solution Ti(IV)OSO₄ (1.9-2.1%, Sigma-Aldrich) coupled with Ultraviolet-visible spectroscopy (UV-Vis). The discharged cathode was removed from the Swagelok type Li—O₂ cell in an argon filled glove box. After drying for 30 minutes in the glove box, the cathode was placed inside an air-tight glass vial capped with a silicone septum. The vial was removed from the glovebox and 1 mL of Ti(IV)OSO₄ solution was injected into the vial through the septum. The vial was swirled for 30 s without removing the syringe to limit air exposure. The entire solution was then withdrawn from the vial and added to a 1 mL quartz cuvette. A control solution of Ti(IV)OSO₄ was also added to a second identical cuvette. Dual beam UV-Vis was performed across a wavelength of 350-800 nm. The absorbance was then correlated to a Li₂O₂ discharge product mass using a previously reported calibration curve [9].

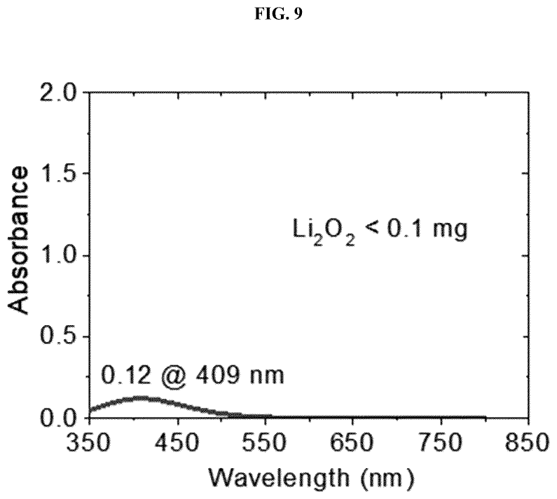

After discharge, the cell was disassembled inside an argon filled glovebox. The cathode with discharge product(s) was dried inside the glovebox, cut in half, and subjected to micro-Raman and titration analysis with Ti(IV)OSO₄ followed by UV-Vis of the titrant in order to determine the chemistry of the discharge product. The UV-Vis absorbance curve and micro-Raman spectra are shown in FIG. 9 and FIG. 4D respectively. The titrant absorbance value of 0.12 indicated that the presence of Li₂O₂ was negligible on the discharged cathode. Raman spectra were collected on several different areas and demonstrated strong LiO₂ characteristic peaks at 1125 and 1505 cm⁻¹, along with the characteristic rGO/graphitic peaks at 1328 and 1596 cm⁻¹ [27]. These results indicate that LiO₂ was the dominant discharge product formed during the deep discharge of a Li—O₂ cell incorporating an Ir₃Li-rGO cathode.

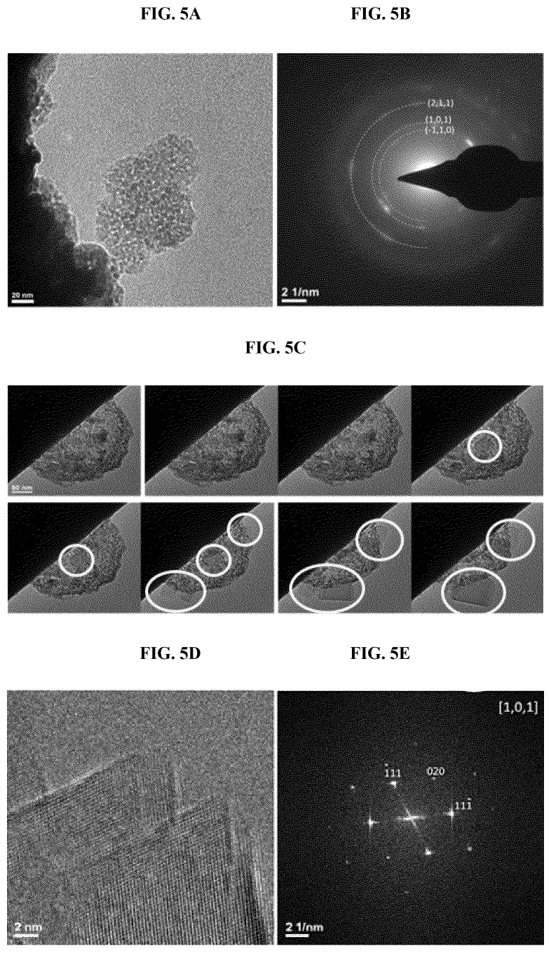

A similar deep discharge was used for investigation of the product(s) by TEM. A low-resolution TEM image of a representative ~80×100 nm large raspberry-shaped discharge product that was attached to the cathode surface is shown in FIG. 5A. The raspberry-shaped secondary particle consisted of smaller primary particles of less than about 5 nm. Additional secondary particles with similar morphologies were also observed on the surface of the larger cathode particles, one of which is shown in FIG. 5C. Selected area electron diffraction (SAED) was performed on the raspberry shaped particle shown, and the diffraction pattern is provided in FIG. 5B. The SAED pattern of the particle is consistent with that of (110), (101), and (211) LiO₂ surfaces. The TEM images taken at 80 kV, shown in FIG. 5, were collected over a two-day time frame, indicating that the LiO₂ particles are thermodynamically stable.

The discharge product morphology was made up of small primary particles that appear to be connected together via amorphous regions to form much larger secondary particles, which suggested several possible formation mechanisms. Previously, experimental and theoretical investigations of other types of materials grown in solution have demonstrated that similar morphologies result from the primary nucleation and growth of crystalline particles from solution, and subsequent diffusion-controlled agglomeration of these primary particles or ‘secondary nucleation’ of new particles on primary particles [28,29]. In the case of the Ir₃Li cathode material in the Li—O₂ cell, the discharge resulted in the formation of secondary particles of ~200 nm in size. These secondary particles were comprised of the very small (<5 nm) primary particles and amorphous regions between them, and were referred as ultra-nanocrystalline lithium superoxide (UNLS).

The UNLS particles were stable under low electron beam accelerating voltage (80 kV), however, they underwent reaction during a high voltage electron beam (200 kV). FIG. 5C is a combination of selected snapshots taken from the electron irradiation of a large hemispheric UNLS particle greater than 200 nm in diameter. It was observed that the original hemispheric UNLS particle reduced in size and new platelet particles formed on the surface of the original particle. Small platelet particles dissolved and redeposited onto larger particles. One platelet particle could grow to 90×70 nm in size. A high-resolution image of the newly formed platelet particle is shown in FIG. 5D. It was observed that the platelet particle was highly crystalline. Electron diffraction was performed on the particle. The diffraction pattern, shown in FIG. 5E, aligned with that of (111), (111), and (020) diffraction peaks of Li₂O (cubic, antifluoride structure). The electron beam irradiation conditions during TEM measurements were far from equilibrium and possible chemical reactions are provided in Equations S8-9. This direct TEM observation provides further evidence that the discharge product is mainly LiO₂, and upon high energy electron irradiation, decomposed to form Li₂O.

Possible LiₓOₓ Reactions During TEM Beam Irradiation.

For TEM, the irradiated electrons were typically absorbed, scattered, or passed through the thin sample. The absorbed and scattered electrons can cause sample heating. The amount of heat deposited (ΔQ) is given by:

$$Δ Q = Δ E ( \frac{I}{e} ) ( \frac{t}{λ} ) , \qquad ( S8 )$$

where ΔE is the energy loss per inelastic collision per electron, I the electron beam current, e electron charge, t sample thickness, and A electron mean free path for all inelastic scattering [4]. Since the only parameter changed was the accelerating voltage from 80 to 200 kV, the increased energy loss (AE) is the main contributor that led to chemical reaction. In other words, the heat generated at 80 kV imaging was balanced by heat loss from thermal conduction and radiation in the vacuum and sample damage was minimized. As the accelerating voltage was increased to 200 kV, the reactions from LiO₂ reduced to an intermediate [LiO₂⁻] (Equation S9a), [LiO₂⁻] anion neutralized with Li⁺ to form Li₂O₂ (Equation S9b) occurred.

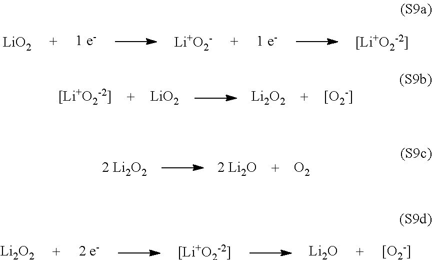

Since Li₂O₂ is an electronic insulator with large band gap, its thermal conductivity is expected to be much lower than that of the LiO₂ and the heat dissipation will be hindered. In fact, Li₂O₂ is reported to undergo thermally activated decomposition/disproportionation to form Li₂O and O₂ (Equation S9c) with onset temperature ~340-348° C. with thermogravimetric analysis (TGA) and differential thermal analysis (DTA) [30]. Report with use of in-situ XRD and XPS measurements further narrowed the Li₂O₂ structural change onset temperature down to 280° C. [31]. Alternatively, Li₂O₂ under electron irradiation may form another intermediate [Li₂O₂²⁻] that dissociated into Li₂O and O²⁻ (Equation S9d).

The results described herein show that large LiO₂ particles were grown and they were remarkably stable. The growth of these large UNLS particles may be due to the use of large (up to 2 μm size) Ir₃Li particles for the cathode that results in ORR as well as nucleation/growth on the same substrate. These results differ from previous studies that used cathodes with small Ir nanoparticles (~2 nm) loaded onto an rGO support, where ORR and growth/nucleation are likely occurring on separate materials [4].

### REFERENCES

[1] D. Aurbach, B. D. McCloskey, L. F. Nazar, P. G. Bruce, Advances in understanding mechanisms underpinning lithium-air batteries, Nat. Energy. 1 (2016)₁₆₁₂₈. https://doi.org/10.1038/nenergy.2016.128.
[2] T. Liu, J. P. Vivek, E. W. Zhao, J. Lei, N. Garcia-Araez, C. P. Grey, Current Challenges and Routes Forward for Nonaqueous Lithium-Air Batteries, Chem. Rev. 120 (2020) 6558-6625. https://doi.org/10.1021/acs.chemrev.9b00545.
[3] J. Chen, J. S. Hummelshøj, K. S. Thygesen, J. S. G. Myrdal, J. K. Nørskov, T. Vegge, The role of transition metal interfaces on the electronic transport in lithium-air batteries, Catal. Today. 165 (2011) 2-9. https://doi.org/10.1016/j.cattod.2010.12.022.
[4] A. Halder, H.-H. Wang, K. C. Lau, R. S. Assary, J. Lu, S. Vajda, K. Amine, L. A. Curtiss, Identification and Implications of Lithium Superoxide in Li—O 2 Batteries, ACS Energy Lett. 3 (2018) 1105-1109. https://doi.org/10.1021/acsenergylett.8b00385.
[5] J. Lu, Y. Jung Lee, X. Luo, K. Chun Lau, M. Asadi, H.-H. Wang, S. Brombosz, J. Wen, D. Zhai, Z. Chen, D. J. Miller, Y. Sub Jeong, J.-B. Park, Z. Zak Fang, B. Kumar, A. Salehi-Khojin, Y.-K. Sun, L. A. Curtiss, K. Amine, A lithium-oxygen battery based on lithium superoxide, Nature. 529 (2016) 1-7. https://doi.org/10.1038/nature16484.
[6] B. Lee, J. Kim, G. Yoon, H.-D. Lim, I.-S. Choi, K. Kang, Theoretical Evidence for Low Charging Overpotentials of Superoxide Discharge Products in Metal-Oxygen Batteries, Chem. Mater. 27 (2015) 8406-8413. https://doi.org/10.1021/acs.chemmater.5b03877.
[7] S. Li, J. Liu, B. Liu, First-Principles Study of the Charge Transport Mechanisms in Lithium Superoxide, Chem. Mater. 29 (2017) 2202-2210. https://doi.org/10.1021/acs.chemmater.6b05022.
[8] S. T. Plunkett, H. Wang, S. H. Park, Y. J. Lee, J. Cabana, K. Amine, S. Al-hallaj, B. P. Chaplin, L. A. Curtiss, Charge Transport Properties of Lithium Superoxide in Li—O₂ Batteries, ACS Appl. Energy Mater. (2020) 3, 12575-12583. https://dx.doi.org/10.1021/acsaem.0c02495
[9] H.-H. Wang, Y. J. Lee, R. S. Assary, C. Zhang, X. Luo, P. C. Redfern, J. Lu, Y. J. Lee, D. H. Kim, T.-G. Kang, E. Indacochea, K. C. Lau, K. Amine, L. A. Curtiss, Lithium Superoxide Hydrolysis and Relevance to Li—O 2 Batteries, J. Phys. Chem. C. 121 (2017) 9657-9661. https://doi.org/10.1021/acs.jpcc.6b12950.
[10] A. Halder, A. T. Ngo, X. Luo, H. H. Wang, J. G. Wen, P. Abbasi, M. Asadi, C. Zhang, D. Miller, D. Zhang, J. Lu, P. C. Redfern, K. C. Lau, R. Amine, R. S. Assary, Y. J. Lee, A. Salehi-Khojin, S. Vajda, K. Amine, L. A. Curtiss, In Situ Formed Ir₃Li Nanoparticles as Active Cathode Material in Li—Oxygen Batteries, J. Phys. Chem. A. 123 (2019) 10047-10056. https://doi.org/10.1021/acs.jpca.9b06875.
[11] H. C. Donkersloot, J. H. N. V. A. N. Vucht, The crystal structure of IrLi, Ir Li and LiRh3, J. Less-Common Met. 50 (1976) 279-282.
[12] B. J. Sangster, A. D. Pelton, The Ir—Li(Iridium-Lithium) System, J. Phase Equilibria. 13 (1992) 59-62.
[13] G. Kresse, J. Furthmüller, Efficiency of ab-initio total energy calculations for metals and semiconductors using a plane-wave basis set, Comput. Mater. Sci. 6 (1996) 15-50. https://doi.org/10.1016/0927-0256 (96) 00008-0.
[14] S. Samira, S. Deshpande, C. A. Roberts, A. M. Nacy, J. Kubal, K. Matesić, O. Oesterling, J. Greeley, E. Nikolla, Nonprecious Metal Catalysts for Tuning Discharge Product Distribution at Solid-Solid Interfaces of Aprotic Li—O₂ Batteries, Chem. Mater. 31 (2019) 7300-7310. https://doi.org/10.1021/acs.chemmater.9b01817.
[15] J. Lu, L. Cheng, K. C. Lau, E. Tyo, X. Luo, J. Wen, D. Miller, R. S. Assary, H. H. Wang, P. Redfern, H. Wu, J. B. Park, Y. K. Sun, S. Vajda, K. Amine, L. A. Curtiss, Effect of the size-selective silver clusters on lithium peroxide morphology in lithium-oxygen batteries, Nat. Commun. 5 (2014) 1-8. https://doi.org/10.1038/ncomms5895.
[16] J. F. Shackelford, Introduction to Materials Science for Engineers, 8th ed., Pearson, 2015. http://web.utk.edu/~prack/mse201/Chapter 5 Diffusion.pdf.
[17] J.-J. Xu, Z.-L. Wang, D. Xu, L.-L. Zhang, X.-B. Zhang, Tailoring deposition and morphology of discharge products towards high-rate and long-life lithium-oxygen batteries, Nat. Commun. 4 (2013) 1-10. https://doi.org/10.1038/ncomms3438.
[18] J. F. Moulder, W. F. Stickle, P. E. Sobol, K. D. Bomben, Handbook of X-ray Photoelectron Spectroscopy Edited by, Perkin-Elmer Corp, Eden Prairie, MN, 1992.
[19] J. M. Allen, W. W. Brennessel, C. E. Buss, J. E. Ellis, M. E. Minyaev, M. Pink, G. F. Warnock, M. L. Winzenburg, V. G. Young, Synthesis, isolation, and characterization of trisodium tricarbonyliridate (3-), Na3[Ir(CO) 3]. Initial studies on its derivative chemistry and structural characterizations of trans-[Ir(CO)3(EPh3) 2]-, E=Ge, Sn, and trans-[Co(CO)3(SnPh3) 2]-, Inorg. Chem. 40 (2001) 5279-5284. https://doi.org/10.1021/ic0105011.
[20] J. E. Ellis, Metal carbonyl anions: From [Fe(CO) 4]2- to [Hf(CO)6]2- and beyond, Organometallics. 22 (2003) 3322-3338. https://doi.org/10.1021/om030105l.
[21] W. Tang, E. Sanville, G. Henkelman, A grid-based Bader analysis algorithm without lattice bias, J. Phys. Condens. Matter. 21 (2009). https://doi.org/10.1088/0953-8984/21/8/084204.
[22] R. Powell, Thermal conductivities and electrical resistivities of the platinum metals, Platin. Met. Rev. 6 (1962) 138.
[23] D. A. Agyeman, M. Park, Y. M. Kang, Pd-Impregnated NiCo2O4 nanosheets/porous carbon composites as a free-standing and binder-free catalyst for a high energy lithium-oxygen battery, J. Mater. Chem. A. 5 (2017) 22234-22241. https://doi.org/10.1039/c7ta05391f.
[24] B. Sun, X. Huang, S. Chen, P. Munroe, G. Wang, Porous graphene nanoarchitectures: An efficient catalyst for low charge-overpotential, long life, and high capacity lithium-oxygen batteries, Nano Lett. 14 (2014) 3145-3152. https://doi.org/10.1021/n1500397y.
[25] F. S. Gittleson, W. H. Ryu, A. D. Taylor, Operando observation of the gold-electrolyte interface in Li—O2 batteries, ACS Appl. Mater. Interfaces. 6 (2014) 19017-19025. https://doi.org/10.1021/am504900k.
[26] N. A. Galiote, U. Ulissi, S. Passerini, F. Huguenin, Role Platinum Nanoparticles Play in the Kinetic Mechanism of Oxygen Reduction Reaction in Nonaqueous Solvents, J. Phys. Chem. C. (2018). https://doi.org/10.1021/acs.jpcc.8b02606.
[27] S. Perumbilavil, P. Sankar, T. Priya Rose, R. Philip, White light Z-scan measurements of ultrafast optical nonlinearity in reduced graphene oxide nanosheets in the 400-700 nm region, Appl. Phys. Lett. 107 (2015) 051104. https://doi.org/10.1063/1.4928124.
[28] A. Carino, A. Testino, M. R. Andalibi, F. Pilger, P. Bowen, C. Ludwig, Thermodynamic-Kinetic Precipitation Modeling. A Case Study: The Amorphous Calcium Carbonate (ACC) Precipitation Pathway Unravelled, Cryst. Growth Des. 17 (2017) 2006-2015. https://doi.org/10.1021/acs.cgd.7b00006.
[29] J. Baumgartner, A. Dey, P. H. H. Bomans, C. Le Coadou, P. Fratzl, N. A. J. M. Sommerdijk, D. Faivre, Nucleation and growth of magnetite from solution, Nat. Mater. 12 (2013) 310-314. https://doi.org/10.1038/nmat3558.
[30] R. A. Nefedov, Y. A. Ferapontov, N. P. Kozlova, Problem of the lithium peroxide thermal stability, IOP Conf. Ser. Mater. Sci. Eng. 112 (2016). https://doi.org/10.1088/1757-899X/112/1/012027.
[31] K. P. C. Yao, D. G. Kwabi, R. A. Quinlan, A. N. Mansour, A. Grimaud, Y.-L. Lee, Y.-C. Lu, Y. Shao-Horn, Thermal Stability of Li₂O₂ and Li₂O for Li-Air Batteries: In Situ XRD and XPS Studies, J. Electrochem. Soc. 160 (2013) A824-A831. https://doi.org/10.1149/2.069306jes.

The present technology may include, but is not limited to, the features and combinations of features recited in the following lettered paragraphs, it being understood that the following paragraphs should not be interpreted as limiting the scope of the claims as appended hereto or mandating that all such features must necessarily be included in such claims:
Paragraph A. A process of forming LiO₂, the process comprising:
providing an electrochemical cell comprising a porous oxygen cathode, a lithium anode, a current collector, and an electrolyte; and
discharging the electrochemical cell to form a discharge product;
wherein:
the porous oxygen cathode comprises a gas-diffusion layer electrode coated with a mixture of reduced graphene oxide (rGO) and Ir₃Li;
the discharge product comprises LiO₂; and
the discharge product is substantially free of Li₂O and Li₂O₂.
Paragraph B. The process of Paragraph A, wherein the porous oxygen cathode is a porous oxygen carbon cathode.
Paragraph C. The process of Paragraph A or B, wherein a mass ratio of rGO:Ir₃Li is from about 1:1 to about 1:0.00005.
Paragraph D. The process of Paragraph C, wherein a mass ratio of rGO:Ir₃Li is about 1:1.
Paragraph E. The process of Paragraphs A-D, wherein the Ir₃Li comprises Ir₃Li particles having a particle size of from about 200 nm to about 5 μm.
Paragraph F. The process of Paragraph A-E, wherein the LiO₂ is crystalline LiO₂.
Paragraph G. The process of Paragraph A-F, wherein the LiO₂ is in a form of secondary particles having a particles size of greater than about 200 nm.
Paragraph H. The process of Paragraph G, wherein the secondary LiO₂ particles comprise LiO₂ primary particles having a particle size of less than about 5 nm.
Paragraph I. The process of Paragraph G, wherein the secondary LiO₂ particles further comprise amorphous regions between the LiO₂ primary particles.
Paragraph J. The process of Paragraph A-I further comprising subjecting a mixture of Ir⁰ and Li⁰ to elevated temperature under an inert atmosphere to form the Ir₃Li, and mixing the Ir₃Li with the rGO.
Paragraph K. The process of Paragraph J, wherein the Ir⁰ is Ir⁰ powder, and the Li⁰ is Li⁰ foil.
Paragraph L. The process of Paragraph J, wherein the elevated temperature is a temperature from about 600° C. to 1000° C.
Paragraph M. The process of Paragraph J, wherein the subjecting is carried out for greater than 5 days.
Paragraph N. The process of Paragraph A-M, wherein a loading of the mixture on the porous oxygen carbon cathode is from about 0.2 to about 1.0 mg/cm².
Paragraph O. The process of Paragraph A-N, wherein the discharging is conducted at a currency of from about 10 mA/g to about 500 mA/g, and a capacity of from about 100 mAh/g to about 2000 mAh/g.
Paragraph P. The process of Paragraph A-O, wherein the discharging is conducted in the presence of O₂.
Paragraph Q. The process of Paragraph A-P, wherein the electrolyte comprises an aprotic solvent and a salt.
Paragraph R. The process of Paragraph Q, wherein the salt is LiCF₃CO₂, LiC₂F₅CO₂, LiClO₄, LiBF₄, LiAsF₆, LiPF₆, LiPF₂ (C₂O₄) ₂, LiPF₄C₂O₄, LiCF₃SO₃, LiN(CF₃SO₂) ₂, LiC(CF₃SO₂) ₃, LiN(SO₂C₂F₅) ₂), lithium alkyl fluorophosphates, Li(C₂O₄) ₂, LiBF₂C₂O₄, Li₂B₁₂X₁₂₋ₚHₚ, Li₂B₁₀X_{10-y}H_{y}, or any combination of two or more thereof, where X is OH, F, CI, or Br; p is 0, 1, 2, 3, 4, 5, 6, 7, 8, 9, 10, 11, or 12; and y is 0, 1, 2, 3, 4, 5, 6, 7, 8, 9, or 10.
Paragraph S. The process of Paragraph Q, wherein the aprotic solvent is an ether-based solvent, a fluorinated ether-based solvent, an oligo (ethylene oxide) solvent, or any combination of two or more thereof.
Paragraph T. A composition comprising LiO₂, reduced graphene oxide (rGO), and Ir₃Li, wherein:
a mass ratio of rGO:Ir₃Li is from about 1:1 to 1:0.00005;
the LiO₂ comprises primary LiO₂ particles formed into secondary LiO₂ particles;
the LiO₂ primary particles are less than about 5 nm;
the LiO₂ secondary particles are greater than 200 nm; and
the composition is substantially free of Li₂O₂ and Li₂O.
Paragraph U. The composition of Paragraph T, wherein the mass ratio of rGO:Ir₃Li is about 1:1.
Paragraph V. The composition of Paragraph T or U, wherein the Ir₃Li is in a form of Ir₃Li particles having a particle size of from about 200 nm to about 5 μm.
Paragraph W. The composition of Paragraph T-V, wherein the primary LiO₂ and the secondary LiO₂ are crystalline.
Paragraph X. The composition of Paragraph W, wherein the crystalline LiO₂ secondary particles further comprise amorphous regions between the LiO₂ primary particles.
Paragraph Y. The composition of Paragraph T-X, wherein the LiO₂ is stable with less than 20% of LiO₂ decomposes after 24 hours at ambient temperature under O₂, Ar, or vacuum.
Paragraph Z. The composition of Paragraph T-Y, wherein the LiO₂ is stable with less than 1% of LiO₂ is decomposed under 80 kV applied voltage during TEM measurement.
Paragraph AA. An electrochemical cell comprising:
an anode comprising lithium metal;
a cathode comprising LiO₂, reduced graphene oxide (rGO), and Ir₃Li; and
an electrolyte;
wherein:
a mass ratio of rGO:Ir₃Li is from about 1:1 to about 1:0.00005,
the cathode is substantially free of Li₂O₂ and Li₂O.
Paragraph BB. The electrochemical cell of Paragraph AA, wherein the mass ratio of rGO:Ir₃Li is about 1:1.
Paragraph CC. The electrochemical cell of Paragraph AA or BB, wherein the Ir₃Li is in a form of Ir₃Li particles having a particle size of from about 200 nm to about 5 μm.
Paragraph DD. The electrochemical cell of Paragraph AA, BB, or CC, wherein the LiO₂ is in a form of crystalline LiO₂ particles having a particles size of greater than 200 nm, wherein the electrolyte comprises a solvent and a lithium salt.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrochemical cell comprising:
an anode comprising lithium metal;
a cathode comprising LiO₂, reduced graphene oxide (rGO), and Ir₃Li; and
an electrolyte;
wherein:
a mass ratio of rGO:Ir₃Li is from about 1:1 to about 1:0.00005; and
the cathode is substantially free of Li₂O₂ and Li₂O.

2. The electrochemical cell of claim 1, wherein the Ir₃Li is in a form of Ir₃Li particles having a particle size of from about 200 nm to about 5 μm.

3. The electrochemical cell of claim 1, wherein the LiO₂ comprises primary LiO₂ particles formed into secondary LiO₂ particles.

4. The electrochemical cell of claim 3, wherein the primary LiO₂ particles are crystalline LiO₂ particles having a particles size of less than about 5 nm.

5. The electrochemical cell of claim 3, wherein the secondary LiO₂ particles are crystalline LiO₂ particles having a particles size of greater than 200 nm.

6. The electrochemical cell of claim 3, wherein the crystalline LiO₂ secondary particles further comprise amorphous regions between the LiO₂ primary particles.

7. The electrochemical cell of claim 1, wherein the electrolyte comprises an aprotic solvent and a salt.

8. The electrochemical cell of claim 7, wherein the salt comprises LiCF₃CO₂, LiC₂F₅CO₂, LiClO₄, LiBF₄, LiAsF₆, LiPF₆, LiPF₂ (C₂O₄) ₂, LiPF₄C₂O₄, LiCF₃SO₃, LiN(CF₃SO₂) ₂, LiC(CF₃SO₂) ₃, LiN(SO₂C₂F₅) ₂), lithium alkyl fluorophosphates, Li(C₂O₄) ₂, LiBF₂C₂O₄, Li₂B₁₂X₁₂₋ₚHₚ, Li₂B₁₀X_{10-y}H_{y}, or any combination of two or more thereof, where X is OH, F, Cl, or Br; p is 0, 1, 2, 3, 4, 5, 6, 7, 8, 9, 10, 11, or 12; and y is 0, 1, 2, 3, 4, 5, 6, 7, 8, 9, or 10.

9. The electrochemical cell of claim 7, wherein the aprotic solvent is an ether-based solvent, a fluorinated ether-based solvent, an oligo (ethylene oxide) solvent, or any combination of two or more thereof.

10. The electrochemical cell of claim 1, wherein the cathode is a porous oxygen cathode.

11. The electrochemical cell of claim 10, wherein the porous oxygen cathode comprises the LiO₂ and Ir₃Li deposited onto a gas-diffusion layer comprising the rGO.

12. The electrochemical cell of claim 1, wherein the anode comprises lithium metal.

13. The electrochemical cell of claim 1, wherein the Ir₃Li is in a form of Ir₃Li particles having a particle size of from about 200 nm to about 5 μm.
